(19) United States
(12) Patent Application Publication
(10) Pub. No.: US 2025/0036378 A1
(43) Pub. Date: Jan. 30, 2025

(54) OBFUSCATION ON EXPOSED PUBLIC API FROM SOFTWARE LIBRARY

(71) Applicant: VISA INTERNATIONAL SERVICE ASSOCIATION, San Francisco, CA (US)

(72) Inventor: Yuexi Chen, Foster City, CA (US)

(73) Assignee: Visa International Service Association, San Francisco, CA (US)

(21) Appl. No.: 18/689,350

(22) PCT Filed: Sep. 13, 2021
(86) PCT No.: PCT/US2021/050037

§ 371 Date: Mar. 5, 2024

(51) Int. Cl. G06F 8/36; G06F 8/41; G06F 9/54

(52) U.S. Cl. CPC G06F 8/36; G06F 8/41; G06F 9/541

(57) ABSTRACT

A method for creating a final application includes a computer obtaining an obfuscated SDK binary and an interface source code that comprises one or more functions that call obfuscated functions within the obfuscated SDK. The computer then creates application source code that calls functions in the interface source code. The computer builds an intermediate object comprising the interface source code and the application source code. The computer then creates the final application using the intermediate object and the obfuscated SDK binary.

### CROSS-REFERENCES TO RELATED APPLICATIONS

None.

### BACKGROUND

Software development kits are commonly provided by first developers to second developers for use. The software development kits need to expose public API methods under various package names, such that the second developers can actually utilize the software development kit. The second developers use the software development kit's exposed API methods in their own applications. For example, the second developers write code that calls (e.g., references) an exposed API method of the software development kit to perform the processing provided by the function as created by the first developers.

Software development kits that deal with sensitive information (e.g., user biometric data, passwords, payment information, social security numbers, vaccination status, etc.) are typically obfuscated, except for the publically exposed API methods. The publically exposed API methods cannot be obfuscated in this model, since obfuscating them would not allow the second developers to utilize the API calls in a meaningful manner. This is because obfuscated function names and their parameters lose their meaning.

When the second developers build their application that includes calls to the exposed API functions, they will also obfuscate their code, since it may also deal with sensitive information. The second developers will obfuscate their application except for the calls to the exposed API functions. The exposed API function calls cannot be obfuscated. This is because, if they were changed, the final application, when run, would not know what function in the SDK is actually being called.

Since the input data and output data to and from these exposed public API methods may be sensitive, malicious parties can look for these exposed public API methods in a static code analysis. For example, a malicious party can place a break point on the exposed public API method during runtime debugging and try to examine the call stack to expose sensitive data and the code execution flow. This poses security threats to all software development kits and any application that uses API functions exposed those software development kits.

Embodiments of the disclosure address this problem and other problems individually and collectively.

### SUMMARY

Embodiments are related to methods and systems for securely obfuscating exposed public API methods.

One embodiment is related to a method for creating a final application, the method comprising: receiving, by a computer, an obfuscated SDK binary and an interface source code that comprises one or more methods that call obfuscated methods within the obfuscated SDK; creating, by the computer, application source code that calls methods in the interface source code; building, by the computer, an intermediate object comprising the interface source code and the application source code; and creating, by the computer, the final application using the intermediate object and the obfuscated SDK.

Another embodiment is related to a computer comprising: a processor; and a computer-readable medium coupled to the processor, the computer-readable medium comprising code executable by the processor for implementing a method for creating a final application, the method comprising: receiving an obfuscated SDK binary and an interface source code that comprises one or more methods that call obfuscated methods within the obfuscated SDK; creating application source code that calls methods in the interface source code; building an intermediate object comprising the interface source code and the application source code; and creating the final application using the intermediate object and the obfuscated SDK. The final application can be later obfuscated.

One embodiment is related to a method of running a final application on a user device, the final application comprising an API call function, an interface function, and a library function, the API call function, the interface function, and the library function being obfuscated, the method comprising: executing, by the user device, the API call function that calls the interface function; executing, by the user device, the interface function that calls the library function; and executing, by the user device, the functionality of the library function.

Further details regarding embodiments of the disclosure can be found in the Detailed Description and the Figures.

### BRIEF DESCRIPTION OF THE DRAWINGS

FIG. 1 shows a block diagram of an API obfuscation system according to embodiments.

FIG. 2 shows a block diagram of components of a development computer according to embodiments.

FIG. 3 shows a flow diagram of a final application creation method according to embodiments.

FIG. 4 shows a flow diagram of a final application execution method according to embodiments.

### DETAILED DESCRIPTION

Prior to discussing embodiments of the disclosure, some terms can be described in further detail.

A “development computer” can include a computer utilized to create something. A development computer can be a personal computer, a workstation, a laptop, a desktop, a virtual machine running on a device, etc. A development computer may have an integrated (software) development environment (IDE) for compiling source code to produce binary executable code.

An “integrated development environment” (IDE) tool can include an application for writing source code. An integrated development environment can include a source code editor, build automation tools, a debugger, a compiler, interpreter, obfuscator, and/or any combination thereof.

“Source code” can include a collection of code written in a human-readable programming language. Source code can be written as plain text. Source code can include source code files, modules, functions, libraries, and/or portions thereof that can be viewed and/or edited in an editing interface of an integrated development environment. Source code can be created by development computer users (e.g., computer programmers, etc.), who specify the actions to be performed by a computer. Source code can be transformed by an assembler or compiler during a build process into binary executable code that can be executed by a computer. The binary executable code can be stored for execution at a later time.

A “build process” can include converting source code files into binary executable code. A build process can include compiling source code. For example, a compilation function can turn source code files into directly executable or intermediate objects. A build process can include obfuscating the code at any suitable level, such as at the source code level or the binary executable code level. A build process can include any other suitable functions including, but not limited to, a version control function and a code quality function.

“Binary” or “binary executable code” can include a low-level programming language including machine language instructions. Binary executable code can be used to control a computer's central processing unit (CPU). Each instruction in the binary executable code can cause the CPU to perform a very specific task, such as a load, a store, a jump, or an arithmetic logic unit (ALU) operation on one or more units of data in the CPU's registers or memory.

An “application” can include a program or piece of software that fulfills a particular purpose.

A “software development kit” (SDK) can include a set of tools for developers to use in producing applications. In some cases, a software development kit can take the form of application programming interfaces (APIs) in the form of on-device libraries of reusable functions used to interface to a particular programming language. In other cases, a software development kit may be as complex as hardware-specific tools that can communicate with a particular embedded system.

An “application programming interface” (API) can include a set of functions and forms connections between computers or computer programs. An application programming interface can allow the creation of applications that access the features or data of an operating system, an application, or other service. An application programming interface can be included in a software development kit. An application programming interface can include functions that aid in developing software.

A “function” can include a particular form of procedure for accomplishing something. A function can be a task performed by a computer. A function can perform predefined operations based on one or more inputs. A function can provide one or more outputs or no outputs. In some cases, a function may be referred to by different names for different programming languages. For example, a function can be referred to as methods, sub-routines, procedures, etc.

An “intermediate object” can include a data construct that provides a description of something that may be used by a computer and comes between two things in time, place, or order. An intermediate object can include a file generated during a build process. For example, an intermediate object can include an object file (e.g., .obj) that is created by a code assembler. An intermediate object can include object code. An intermediate object can be combined with library code and/or SDK code.

A “digital distribution platform” can include one or more computers that disseminate digital programs. A digital distribution platform can include a server computer, a network of computers, a cloud storage system, and/or any other suitable device that aids in distributing digital programs. For example, a digital distribution platform can include an application store. A digital distribution platform can include a digital platform intended to allow search and review of software titles or other media offered electronically. The digital destruction platform provides a secure, uniform experience that automates the electronic acquisition, decryption, and installation of software applications and/or other digital media.

A “user device” may be a device that is operated by a user. Examples of user devices may include a mobile phone, a smartphone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Some embodiments of the disclosure allow for creation of a software development kit that can include one or more application programming interfaces (APIs) that include exposed public methods, which, when compiled into a final application by a development computer, become obfuscated such that a malicious entity cannot examine the final application binary to find the API method calls.

As an illustrative example of current methods, to compare them to methods provided by the invention and the technical advantages provided therefrom, a first developer can create a software development kit that includes the SDK source code as shown in Table 1. The SDK source code in Table 1 illustrates a function called getToken, which is included in a com.comp namespace. The getToken function can perform the operations in the column on the right of Table 1.

TABLE 1
Example SDK Source Code
SDK Source Code

| | |
|---|---|
| com.comp.getToken( ) | |
| ^{└} | com.comp.cbp.getKey |
| | ^{└}com.comp.core.generateToken( ) |
| com.comp.getToken( ) | |

The first developer can build the SDK source code to form SDK binary. The SDK binary obfuscated shown in Table 2 is obfuscated according to typical methods. For example, existing obfuscation configuration (e.g., ProGuard, DexGuard) software only obfuscates the internal packages and methods (e.g., private methods), while the exposed public method(s) are not obfuscated so that a second developer can call the exposed public methods. For example, the processing performed by the getToken method, in Table 2, is obfuscated to perform “c.xv.lo( )” rather than “com.comp.cbp.getKey.”

TABLE 2
Example Obfuscated SDK Binary
Obfuscated SDK Binary

| | |
|---|---|
| com.comp.getToken( ) | |
| ^{└} | c.xv.lo( ) |
| | ^{└}c.yt.8p8( ) |
| com.comp.getToken( ) | |

The first developer then provides the obfuscated SDK binary to a second developer such that the second developer can utilize the SDK when creating an application for users. The second developer can create application source code that calls the public exposed functions of the obfuscated SDK binary to utilize the functions created by the first developer. For example, Table 3 illustrates application source code that calls functions from the obfuscated SDK binary. According to typical methods, the obfuscated SDK binary exposed public functions cannot be obfuscated, because the second developer needs to call these exposed public functions in the application source code.

TABLE 3
Example Application Source Code That Calls The Obfuscated SDK Binary

| Application Source Code | | Obfuscated SDK Binary | |
|---|---|---|---|
| com.industry.app.main( ) | | | |
| ^{└} | com.industry.app.payUI.start( ) | | |
| | ^{└}com.industry.app.payUI.go( ) | | |
| | ^{└}com.industry.app.core.process( ) | →com.comp.getToken( ) | |
| | | ^{└} | c.xv.lo( ) |
| | | | ^{└}c.yt.8p8( ) |
| | com.industry.app.core.process( ) | ←com.comp.getToken( ) | |
| | ^{└}com.bank.app.payUI.done( ) | | |

Once the second developer finishes creating the application source code, the application source code is built into application binary. Further, the application binary is obfuscated. However, the second developer cannot access the SDK binary to also obfuscate the exposed public functions in the SDK binary. So the second developer creates obfuscated application binary that calls exposed public function calls of the otherwise obfuscated SDK binary, as illustrated in Table 4.

TABLE 4
Example Obfuscated Application Source Code
That Calls The Obfuscated SDK Binary

| Obfuscated Application binary | | Obfuscated SDK binary | |
|---|---|---|---|
| com.bank.app.main( ) | | | |
| ^{└} | g.uL.1p4( ) | | |
| | ^{└}g.mq.p( ) | | |
| | ^{└}k.w6f.a( ) | →com.comp.getToken( ) | |
| | | ^{└} | c.xv.lo( ) |
| | | | ^{└}c.yt.8p8( ) |
| | k.w6f.a( ) | ←com.comp.getToken( ) | |
| | ^{└}g.lt.t6( ) | | |

The weak point of security is the exposed public function calls that are called from the obfuscated application binary to the obfuscated SDK binary, as these public functions are not obfuscated like the rest of the binary. If these exposed public functions were to be obfuscated, for example, by obfuscating com.comp.getToken( ) to p.re.f09( ), then the second developer that is developing the application will not be able to invoke the function as each build process of SDK will obfuscate the package and method name differently in a random manner. This makes it difficult to track and call the ever changing function name. Also the function p.re.f09( ) will confuse the application developer, since it is not a human friendly name.

Embodiments solve the above noted technical problems with exposed public function calls in an otherwise obfuscated SDK binary. For example, embodiments provide for the creation of interface source code that maps obfuscated functions in the obfuscated SDK binary to publically accessible functions, where the interface source code is configured to be later obfuscated without breaking the link between second developer calls of the exposed functions and the obfuscated SDK binary functionality. Such systems and methods are described in further detail below.

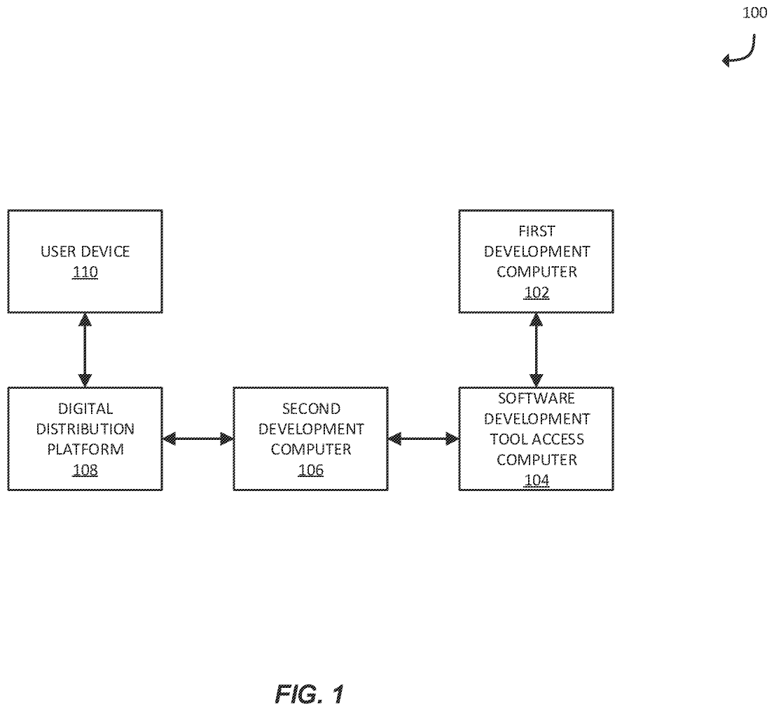

FIG. 1 shows a system 100 according to embodiments of the disclosure. The system 100 comprises a first development computer 102, a software development tool access computer 104, a second development computer 106, an digital distribution platform 108, and a user device 110. The first development computer 102 can be in operative communication with the software development tool access computer 104. The second development computer 106 can be in operative communication with the software development tool access computer 104 and the digital distribution platform 108. The digital distribution platform 108 can be in operative communication with the user device 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between at least the devices in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The first development computer 102 can include a personal computer, a workstation, a laptop, a desktop, a virtual machine running on a device, etc. The first development computer 102 can include a computer utilized to create a software development kit (SDK). The first development computer 102 has an integrated software development environment (IDE) for compiling source code to produce binary executable code.

The first development computer 102 can create source code files for the SDK. In some embodiments, the source code files can be stored in source code repository, which may be internal or external to the first development computer 102. For example, the source code repository may include the various source code files for the project as well as other data for the project. The source code repository may include a code versioning system that manages the source code files. The code versioning system allows developers to obtain source code to modify and commit modified source code as a new version in the code versioning system.

Once the developer of the first development computer 102 writes the SDK source code, the first development computer 102 can build the SDK source code to form obfuscated SDK binary and interface source code. For example, the IDE tool on the first development computer 102 may receive an input to build the SDK source code. The first development computer 102 can utilize a compiler to build the SDK source code into an executable (e.g., SDK binary). While compiling the SDK source code, the IDE tool compiler determines whether any warnings have been generated. Further, while compiling the SDK source code, an obfuscation module can obfuscate the SDK binary.

The first development computer 102 can also generate the interface source code using a mapping table of obfuscated function names obtained from the obfuscation module, as described in further detail herein.

The first development computer 102 can provide the obfuscated SDK binary and the interface source code to the software development tool access computer 104.

The software development tool access computer 104 can include a server computer, a computer, a database, etc. that allows other devices to access software development tools. For example, the software development tool access computer 104 can allow the second development computer 106 to obtain the obfuscated SDK binary and the interface source code created by the first development computer 102.

The second development computer 106 can include a personal computer, a workstation, a laptop, a desktop, a virtual machine running on a device, etc. The second development computer 106 can include a computer utilized to create a final application. The second development computer 106 has an integrated software development environment (IDE) for compiling source code to produce binary executable code. The second development computer 106 can be similar to the first development computer 102.

The second development computer 106 can develop final application source code. For example, a developer can write the final application source code in an IDE or other suitable program included in the second development computer 106. The final application source code can reference the interface source code received from the software development tool access computer 104. For example, the final application source code can call API functions (e.g., exposed public functions) of the interface source code, where the interface source code calls obfuscated library functions included in the SDK binary, as described in further detail herein.

The second development computer 106 can compile the final application source code to form final application binary. The final application binary can be obfuscated to form obfuscated final application binary. The final application binary can be obfuscated such that both the final application source code written by the developer as well as the interface source code are obfuscated. Since the API function calls in the interface source code are in a source code layer, they can be obfuscated without breaking the link between the interface source code functions and the obfuscated SDK binary functions. As such the final application binary can be fully obfuscated as compared to previous methods, where the API function calls could not be obfuscated without breaking the link to the SDK.

The second development computer 106 can provide the final application binary, which is obfuscated, to the digital distribution platform 108.

The digital distribution platform 108 can include a server computer, a computer, a database, etc. that allows user devices to access applications. For example, the digital distribution platform 108 can store the obfuscated final application binary and can provide the obfuscated final application binary to user devices upon request.

The user device 110 can include a mobile phone, a smart phone, a card, a personal digital assistant (PDA), a laptop computer, a desktop computer, etc. operated by a user. The user device 110 can obtain and install applications from the digital distribution platform 108. For example, the user device 110 can obtain the final application (specifically the obfuscated final application binary) from the digital distribution platform 108. The user device 110 can then install the final application. After the final application is installed on the user device 110, the user device 110 can execute the final application.

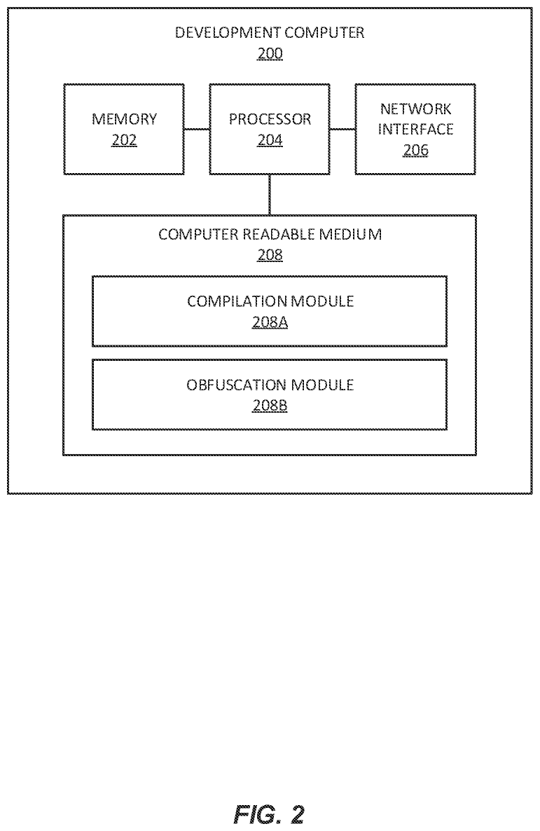

FIG. 2 shows a block diagram of a development computer 200 according to embodiments. The exemplary development computer 200 may comprise a processor 204. The processor 204 may be coupled to a memory 202, a network interface 206, and a computer readable medium 208. The computer readable medium 208 can comprise a compilation module 208A and an obfuscation module 208B.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store source code, obfuscated SDK(s), interface source code, etc.

The computer readable medium 208 may comprise code, executable by the processor 204, for performing a method for creating a final application, the method comprising: receiving, by a computer, an obfuscated SDK binary and an interface source code that comprises one or more methods that call obfuscated methods within the obfuscated SDK; creating, by the computer, application source code that calls methods in the interface source code; building, by the computer, an intermediate object comprising the interface source code and the application source code; and creating, by the computer, the final application using the intermediate object and the obfuscated SDK.

The compilation module 208A may comprise code or software, executable by the processor 204, for compiling source code. The compilation module 208A, in conjunction with the processor 204, can convert source code files into executable code. For example, the compilation module 208A, in conjunction with the processor 204, can convert source code files that are written in a human-readable programming language (e.g., a high-level programming language) to a low-level programming language that can include machine language instructions. As another example, the compilation module 208A, in conjunction with the processor 204, can convert source code files into an binary executable code that is to be passed to the obfuscation module 208B for obfuscation.

The obfuscation module 208B can include may comprise code or software, executable by the processor 204, for obfuscating. The obfuscation module 208B, in conjunction with the processor 204, can obfuscate binary executable code. For example, the obfuscation module 208B, in conjunction with the processor 204, can receive binary executable code from the compilation module 208A, then obfuscate the binary executable code.

The obfuscation module 208B, in conjunction with the processor 204, can obfuscate the binary executable code in any suitable manner. For example, the obfuscation module 208B, in conjunction with the processor 204, can obfuscate the binary executable code using renaming, packing, control flow, instruction pattern transformation, dummy code insertion, metadata removal, opaque predicate insertion, string encryption, code transposition, and/or any combination thereof, as known to one of skill in the art. For example, renaming can include the obfuscation module 208B, in conjunction with the processor 204, modifying the variable and method names, making the code difficult for a human to understand, while, maintaining the program execution behavior.

The network interface 206 may include an interface that can allow the development computer 200 to communicate with external computers. The network interface 206 may enable the development computer 200 to communicate data to and from another device (e.g., a software development tool access computer, an digital distribution platform, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

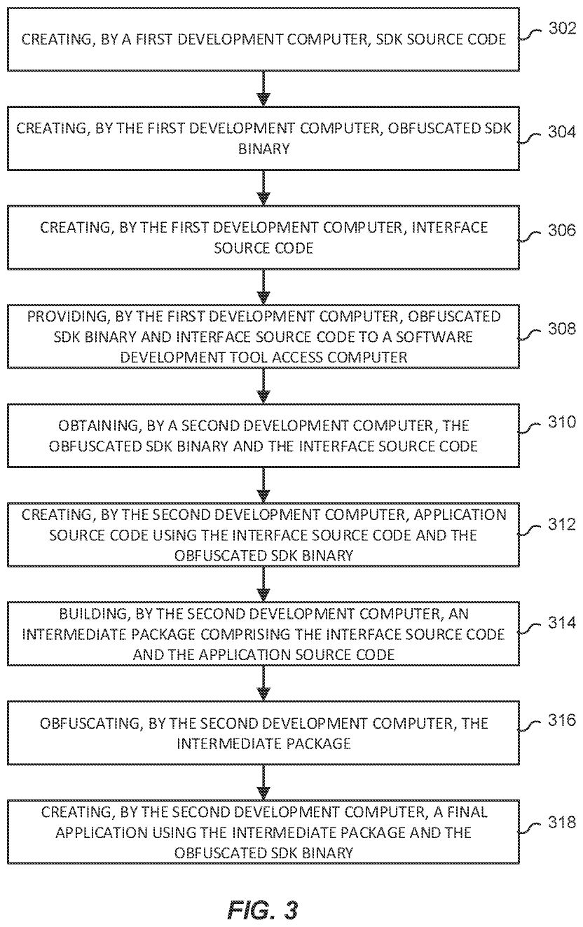

FIG. 3 shows a flow diagram of a final application creation method according to embodiments. The method illustrated in FIG. 3 will be described in the context of a first developer creating a software development kit (SDK) that is to be utilized by a plurality of other developers, including a second developer computer. It is understood, however, that the invention can be applied to other circumstances.

Embodiments can allow for a first developer computer to create an SDK that can include API methods usable (e.g., callable) by other developers that utilize the SDK. In particular, embodiments can allow for the first developer to create the SDK where the exposed API methods are not in a binary level (e.g., compiled), but rather in a source code layer (e.g., not yet compiled). By doing so, the downstream developers can call the exposed API methods in the source code layer, while the functionality of the code is obfuscated in the binary level. When the downstream developers build and release final applications, the exposed API methods in the source code layer will be obfuscated along with the application's source code. Thus, obfuscating the API calls to the SDK in the final application.

As a brief example, prior to discussing the method of FIG. 3, this can be achieved in the following manner. At the time of building the SDK, a first development computer can obfuscate all internal methods and exposed public API methods in the release binary file, while keeping the mapping relationship between obfuscated method names and exposed public API method names. Then, the first development computer can create an interface source code, which exposes the public API methods and converts the calls to obfuscated method calls in the SDK (e.g., in the release binary file). The first development computer can then distribute the interface source code and the SDK binary, for example, to a second development computer. The second development computer can import the interface source code and the SDK binary and can invoke the exposed public API methods in the source code level. The second development computer can build the final application and obfuscate all internal methods including the interface source code. By doing so, the public method is obfuscated in binary, while keeping the public method calls in the source code level for integration and human-readability.

At step 302, the first development computer can create SDK source code. A first developer can operate the first development computer to write SDK source code that can perform certain functionalities. The SDK source code can include any suitable functionalities. For example, the SDK source code can include methods to accomplish goals. The methods can range from simple to complex. For example, one method can be to generate a random value, another method may be to obtain a secure token value, while yet another method may be to securely transmit a data packet to a designated device. The SDK source code can include a plurality of methods that may relate to one another in some way. For example, the SDK can be a social media based kit that can include methods relating to the creation, management, upkeep, etc. of a social media application. As another example, the SDK can be a secure interaction based kit that can include methods relating to generating, processing, etc. interactions.

Table 5, below, illustrates an example function that can be included in the SDK source code. The example function is a method to obtain a token and called “getToken( ).” The getToken function can be library function included in the SDK. The getToken function can perform various functionality, as illustrated in the column on the right in Table 5. For example, the getToken function can get a key (e.g., a cryptographic key) and generate a token by calling a generateToken function “generateToken( ),” which can be another function included in the SDK source code, and later be obfuscated if it only referenced internally to the SDK source code.

TABLE 5
Example SDK Source Code Method
SDK source

| | |
|---|---|
| →com.comp.getToken( ) | |
| ^{└} | com.comp.cbp.getKey |
| | ^{└}com.comp.core.generateToken( ) |
| ←com.comp.getToken( ) | |

At step 304, the first development computer can create an obfuscated SDK binary based on the SDK source code. The first development computer can obfuscate the SDK source code during a build process to create the obfuscated SDK binary. Any suitable obfuscation process can be utilized to obfuscate the SDK source code. For example, the obfuscation process can include renaming, packing, control flow, instruction pattern transformation, dummy code insertion, metadata removal, opaque predicate insertion, string encryption, code transposition, and/or any combination thereof, as known to one of skill in the art. The obfuscation process can cover all packages and methods including internal (e.g., private) and public exposed APIs.

The first development computer can create the obfuscated SDK binary by first compiling the SDK source code to SDK binary. The first development computer can then obfuscate the SDK binary. As an example, the first development computer can obfuscate the SDK binary using renaming. The example getToken( ) method illustrated in Table 6, below, can be renamed in the SDK binary as f09( ). Similarly, the classes from which getToken( ) resides (e.g., com.comp) can also be renamed as p.re. Thus, the function call of com.comp.getToken( ) can be renamed in the SDK binary as p.re.f09( ).

The first development computer can track the renaming of each object in the SDK binary for use in creating interface source code during step 306. For example, the first development computer can store a mapping table that maps the original names to the new names. For example, the mapping between before and after obfuscation of public exposed APIs is recorded by first development computer (e.g., com.comp.getToken( )=p.re.f09( )).

TABLE 6
Example SDK Source Code Method and Obfuscated Binary

| | | Obfuscated SDK | |
|---|---|---|---|
| SDK source | | binary | |
| →com.comp.getToken( ) | | →p.re.f09( ) | |
| ^{└} | com.comp.cbp.getKey | ^{└} | c.xv.lo( ) |
| | ^{└}com.comp.core.generateToken( ) | | ^{└}c.yt.8p8( ) |
| ←com.comp.getToken( ) | | ←p.re.f09( ) | |

At step 306, after obfuscating the SDK binary during the build process, the first development computer can create the interface source code. The first development computer can create the interface source code using the mapping table. The interface source code can be a link between publically exposed methods and obfuscated SDK binary methods. For example, the first development computer can create the interface code that maps the getToken( ) method to the renamed method of f09( ).

In particular, the interface source code can be written in a human readable programming language (which may be the same language as the SDK source code). The interface source code, as illustrated in Table 7, below, can first indicate that the SDK binary is to be used (e.g., imported).

The interface source code can include a method that maps the original SDK source code method name (e.g., getToken( )) to the obfuscated SDK binary method name (e.g., f09( )). For example, the interface source code illustrated in Table 7 includes a public method declaration called getToken( ) that requires a string as input and returns a string. The input string is named PanNumber. The getToken( ) method calls the f09( ) method of the obfuscated SDK binary and passes the PanNumber to the f09( ) method as input. The input string of the f09( ) method has been renamed as_xLtV. The getToken( ) method then returns the output of the f09( ) method.

TABLE 7
Example Interface Source Code

```
package com.comp;
//import obfuscated SDK
import p.re;
public comp( ) {
  // Create a constructor for the obfuscated SDK library
  new re( );
}
public String getToken(String PanNumber) {
  // Use the mapping to translate the call from getToken to re.f09,
  // and PanNumber parameter to _xLtV parameter
  return re.f09(_xLtV);
}
```

TABLE 8
Example Interface Source Code with Obfuscated SDK Binary

| | |
|---|---|
| Interface source | Obfuscated SDK binary |

| | | |
|---|---|---|
| com.comp.getToken( ) | →p.re.f09( ) | |
| | ^{└} | c.xv.lo( ) |
| | | ^{└}c.yt.8p8( ) |
| com.comp.getToken( ) | ←p.re.f09( ) | |

At step 308, after creating the interface source code, the first development computer provides the obfuscated SDK binary and the interface source code (which may collectively be referred to as an SDK), as illustrated in Table 8, to a software development tool access computer. For example, the obfuscated SDK binary and the interface source code can be uploaded to the software development tool access computer, which can be a code repository accessible by a plurality of other developers.

At step 310, a second development computer can obtain the obfuscated SDK binary and the interface source code from the software development tool access computer. For example, the second development computer can download the obfuscated SDK binary and the interface source code.

In some embodiments, the second development computer can generate and provide a software development kit request message to a software development tool access computer requesting the obfuscated SDK binary and the interface source code. The software development tool access computer can generate a software development kit response message comprising the obfuscated SDK binary and the interface source code. The software development tool access computer can provide the software development kit response message to the second development computer. The second development computer can receive the software development kit response message from the software development tool access computer comprising the obfuscated SDK binary and the interface source code.

At step 312, after obtaining the obfuscated SDK binary and the interface source code, the second development computer can create application source code using the interface source code and the obfuscated SDK binary. The second development computer can create any suitable application and can utilize all or some of the interface source code's exposed methods.

For example, an operator of the second development computer can write application source code. The application source code can perform any type of processing. For example, the application source code may be intended to be a social media application, a secure communication application, a secure interaction application, a banking application, a photo editing application, a gaming application, a utility application, etc.

The application source code can call one or more functions in the interface source code. For example, the application source code can call the getToken( ) application included in the interface source code, as illustrated in Table 7, above.

Table 9, below, illustrates example application source code alongside the SDK binary. For example, the final application source code can include any functionality programmed by the second developer. The final application source code can include one or more calls to functions within the interface source code. For example, the getToken function (bolded in Table 9) is called by the final application source code. The getToken function of the interface source code, then calls the associated obfuscated function in the SDK binary. Namely, the interface source code function getToken calls the p.re.f09 function in the obfuscated SDK binary.

TABLE 9
Final Application Source Code with Obfuscate SDK Binary

| | | | Obfuscated SDK | |
|---|---|---|---|---|
| Final Application Source Code | | Interface source | Binary | |
| com.industry.app.main( ) | | | | |
| ^{└} | com. industry.app.payUI.start( ) | | | |
| | ^{└}com.industry.app.payUI.go( ) | | | |
| | ^{└}com.industry.app.core.process( ) | | | |
| | ^{└}com.industry.getToken( ) | | | |
| | | ^{└}com.comp.getToken( ) | →p.re.f09( ) | |
| | | | ^{└} | c.xv.lo( ) |
| | | | | ^{└}c.yt.8p8( ) |
| | | com.comp.getToken( ) | ←p.re.f09( ) | |
| | com.industry.app.core.process( ) | | | |
| | ^{└}com.industry.app.payUI.done( ) | | | |

At step 314, after creating the application source code, the second development computer can build an intermediate object comprising the interface source code and the application source code. The second development computer can build the application source code in any suitable manner. The build process can include compiling the source code (e.g., including both the interface source code and the application source code) to form an intermediate object. The intermediate object can include binary code formed from the source code.

At step 316, further during the build process, after compiling the source code, the second development computer can obfuscate the binary code of the intermediate object. The second development computer can obfuscate the binary code in any suitable manner, as described herein.

For example, the second development computer can obfuscate the intermediate object by obfuscating a first set of function names of the one or more functions included in the interface source code. Further, the second development computer can obfuscate a second set of function names included in the application source code.

For example, Table 10, below, illustrates the obfuscated final application binary and the obfuscated SDK binary. At this point, every function has been obfuscated except for the root function which needs to not be obfuscated such that the CPU can correctly refer to and execute the root function.

TABLE 10
Obfuscated Application Binary with Obfuscated SDK Binary

| Obfuscated Final Application | | | |
|---|---|---|---|
| Binary | | Obfuscated SDK binary | |
| com.industry.app.main( ) | | | |
| ^{└} | g.uL.1p4( ) | | |
| | ^{└}g.mq.p( ) | | |
| | ^{└}k.w6f.a( ) | | |
| | ^{└}r.eg.q71( ) | →p.re.f09( ) | |
| | | ^{└} | c.xv.lo( ) |
| | | | ^{└}c.yt.8p8( ) |
| | | ←p.re.f09( ) | |
| | k.w6f.a( ) | | |
| | ^{└}g.lt.t6( ) | | |

At step 318, the second development computer can create the final application using the intermediate object and the obfuscated SDK. For example, the second development computer package together the intermediate object and the obfuscated SDK to form the final application that is to be distributed.

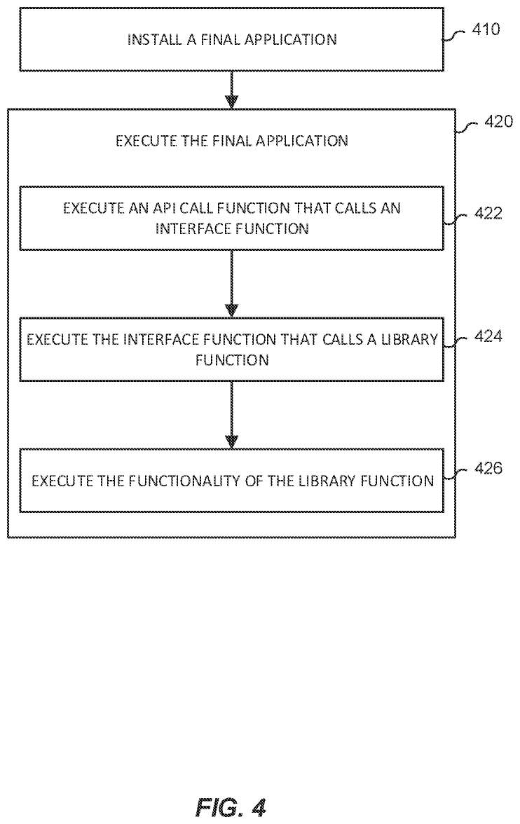

FIG. 4 shows a flow diagram of a final application execution method according to embodiments. The method illustrated in FIG. 4 will be described in the context of a user device executing a final application. The final application is the final application created by the second development computer in FIG. 3. It is understood, however, that the invention can be applied to other circumstances.

Prior to step 410, the user device can obtain a final application. For example, the user device can request the final application from an digital distribution platform. The user device can generate a final application request message to request the final application. The user device can provide the final application request message to the digital distribution platform. Upon receiving the final application request message, the digital distribution platform can generate a final application response message comprising the final application. The digital distribution platform then provides the final application response message to the user device.

At step 410, the user device can install the final application. Installing the final application can include making the final application ready for execution on the user device. The user device can install the application in any suitable manner using any suitable installer as known to one of skill in the art.

At step 420, after installing the final application, the user device can execute the final application. The user device can execute the final application by reading and acting on the instructions of final application binary included in the final application. Each instruction of the final application is a description of a particular action which must be carried out, for example, in order for a specific problem to be solved via one or more instructions. As the executing machine (e.g., the user device) follows the instructions, specific effects are produced in accordance with the semantics of the instructions. Steps 422, 424, and 426 are three such instructions that the user device can execute. The processing during steps 422, 424, and 426 can be specified during the development of the final application, as described in FIG. 3.

The final application can include an API call function, an interface function, and a library function where the API call function, the interface function, and the library function are obfuscated. For example, the API call function in the final application can originate from a call function in the final application source code that calls an interface function in the interface source code. The interface function in the interface source code calls an obfuscated library function in an obfuscated SDK binary file. When the source code is built, the API call function and the interface function can be obfuscated. The library function can already be obfuscated during creation of the obfuscated SDK binary.

At step 422, the user device can execute an API call function that calls an interface function. The API call function can be a function originally written in the final application source code that references a function in the interface source code (e.g., the interface function. The API call function can be, for example, a method call. The interface function can be called by the API call function and can include functionality that calls a library function in the obfuscated SDK binary (which is also included in the final application). The user device can execute the API by call function by processing the binary code in the final application that represents the API call function. As such, the execution of the API call function results in calling the interface function.

At step 424, the user device can execute the interface function that calls a library function. For example, the interface function can be originally written in the interface source code and can call the obfuscated library function included in the SDK binary by a first developer, as described herein. The execution of the obfuscated interface function results in calling the obfuscated library function.

At step 426, the user device can execute the functionality of the obfuscated library function. The obfuscated library function can include any functionality as created by the first developer. The obfuscated library function can include any suitable functionality as created by the first developer. For example, the obfuscated library function can generate and return a token. As another example, the obfuscated library function can create a secure communication channel with a specified device. As yet another example, the obfuscated library function can initiate a machine learning process.

In some embodiments, the user device can execute the final application at step 420 any number of times. In some embodiments, the user device can execute different functions within the final application based upon user input. For example, the user device can execute a first API call function that calls a first interface function, a second API call function that calls a second interface function, a third API call function that calls a third interface function, etc.

Embodiments of the disclosure have a number of advantages. For example, publically exposed methods in software development kits can both be 1) called in an application and 2) be obfuscated in the application when built without breaking the link to the SDK.

For example, in previous methods, the publically exposed methods in an SDK binary could not be obfuscated, since other developers need to access the publically exposed methods in a meaningful manner. This leads to the problem that when the other developers build their application they obfuscate all of their code, except for the calls to the publically exposed methods of the SDK. If the calls to the publically exposed methods of the SDK were obfuscated in the final application, then the final application would not work since an executing device would not know what the obfuscated call actually refers to since the name would differ from the publically exposed method name.

Malicious parties then exploit the fact that the publically exposed method names are still present in the final application. The malicious parties can attack these publically exposed method names to attempt to steal sensitive data.

Embodiments solve these security risks. For example, embodiments provide for technical solutions that effectively hides the exposed public API method, but at the same time makes sure that the connection between the final application and obfuscated SDK binary can be developed, debugged, and executed.

Embodiments provide the technical solutions by introducing interface source code that maps obfuscated functions in the obfuscated SDK binary to publically exposed method names. When a developer creates an application, the interface source code publically exposed method names can be called by the application source code. Since both 1) the publically exposed method in the interface source code and 2) the calls to the publically exposed method in the application source code are both written in source code, they both can be obfuscated in the final application binary. They can both be obfuscated since both function names (e.g., the call name and the function name) can be obfuscated to the same alternate name (e.g., from getToken to f09).

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method for creating a final application, the method comprising:
obtaining, by a computer, an obfuscated SDK binary and an interface source code that comprises one or more functions that call obfuscated functions within the obfuscated SDK binary;
creating, by the computer, application source code that calls functions in the interface source code;
building, by the computer, an intermediate object comprising the interface source code and the application source code; and
creating, by the computer, the final application using the intermediate object and the obfuscated SDK binary.

2. The method of claim 1 further comprising:
obfuscating, by the computer, the intermediate object.

3. The method of claim 2, wherein obfuscating the intermediate object includes:
obfuscating a first set of function names of the one or more functions included in the interface source code; and
obfuscating a second set of function names included in the application source code.

4. The method of claim 1, wherein the interface source code is written in a human-readable programming language prior to building the intermediate object, wherein the application source code is written in a human-readable programming language prior to building the intermediate object, and wherein the obfuscated SDK binary is obfuscated code written in a low-level programming language including machine language instructions.

5. The method of claim 1, wherein the obfuscated SDK binary and the interface source code are obtained from a software development tool access computer.

6. The method of claim 1, wherein the computer is a second development computer, and wherein a first development computer creates the obfuscated SDK binary and the interface source code and provides the obfuscated SDK binary and the interface source code to a software development tool access computer.

7. The method of claim 6, wherein during creating the obfuscated SDK binary and the interface source code, the first development computer creates SDK source code, compiles the SDK source code into SDK binary, obfuscates the SDK binary into obfuscated SDK binary, and creates the interface source code based on obfuscating the SDK binary into obfuscated SDK binary.

8. The method of claim 1, wherein the final application includes one or more obfuscated function calls that call the one or more functions in the interface source code, which are also obfuscated.

9. The method of claim 1 further comprising:
providing, by the computer, the final application to a digital distribution platform, where the digital distribution platform provides the final application to one or more user devices upon request, wherein upon receiving the final application, a user device of the one or more user devices executes the final application.

10. A computer comprising:
a processor; and
a computer-readable medium coupled to the processor, the computer-readable medium comprising code executable by the processor for implementing a method for creating a final application, the method comprising:
obtaining an obfuscated SDK binary and an interface source code that comprises one or more functions that call obfuscated functions within the obfuscated SDK binary;
creating application source code that calls functions in the interface source code;
building an intermediate object comprising the interface source code and the application source code; and
creating the final application using the intermediate object and the obfuscated SDK binary.

11. The computer of claim 10, wherein obtaining the obfuscated SDK binary and the interface source code further comprises:
providing, by the computer, a software development kit request message to a software development tool access computer requesting the obfuscated SDK binary and the interface source code; and
receiving, by the computer, a software development kit response message from the software development tool access computer comprising the obfuscated SDK binary and the interface source code.

12. The computer of claim 10, wherein the obfuscated SDK binary includes the obfuscated functions which process obfuscated processing steps.

13. The computer of claim 10, wherein the method further comprises:
providing the final application to a digital distribution platform, wherein the digital distribution platform provides the final application to one or more user devices upon request to provide the final application by the one or more user devices.

14. The computer of claim 13, wherein the one or more user devices execute the final application.

15. The computer of claim 10, wherein the intermediate object includes object code created from the interface source code and the application source code.

16. The computer of claim 10, wherein the computer is a second development computer, and wherein a first development computer creates the obfuscated SDK binary and the interface source code and provides the obfuscated SDK binary and the interface source code to a software development tool access computer that is accessible by the second development computer.

17. A method of running a final application on a user device, the final application comprising an API call function, an interface function, and a library function, the API call function, the interface function, and the library function being obfuscated, the method comprising:
executing, by the user device, the API call function that calls the interface function;
executing, by the user device, the interface function that calls the library function; and
executing, by the user device, the functionality of the library function.

18. The method of claim 17 further comprising:
obtaining, by the user device, the final application from a digital distribution platform, wherein the digital distribution platform previously obtained the final application from a development computer that created the final application.

19. The method of claim 17, wherein the library function is a function included in an SDK binary.

20. The method of claim 17, wherein the user device is a smartphone, and the final application is a secure interaction application, and wherein the secure interaction application processes interactions by at least executing the functionality of the library function.
